(19) United States
(12) Patent Application Publication
(10) Pub. No.: US 2025/0240294 A1
(43) Pub. Date: Jul. 24, 2025

(54) USER IDENTIFICATION SYSTEM

(71) Applicant: HANSCAN HOLDINGS LIMITED, St. Peter Port (GG)

(72) Inventor: Klaas Johannes ZWART, St. Peter Port (GG)

(73) Assignee: HANSCAN HOLDINGS LIMITED, St. Peter Port (GG)

(21) Appl. No.: 18/840,886

(22) PCT Filed: Feb. 23, 2023
(86) PCT No.: PCT/EP2023/054615

§ 371 Date: Aug. 22, 2024

(30) Foreign Application Priority Data
Feb. 23, 2022 (NL) 2031049

(51) Int. Cl. H04L 9/40

(52) U.S. Cl. CPC H04L 63/10; H04L 63/083; H04L 63/123

(57) ABSTRACT

A system is provided comprising an access controller that can grant—or deny to a person or device an access to a location or premises, a service provided via an electronic access point like a web shop. The access is denied or granted based on an identification of a user by means of an electronic computing device. The device is arranged to collect data identifying the user, like biometric data and to verify whether the data received matches data related to a user, which data has been received before. The system further comprises a trusted platform server. Upon successful identification of the user, the personal computing device confirms the identification to the trusted platform. The trusted platform notifies the access controller that identification was successful and the access controller may thereupon grant the requested access.

### TECHNICAL FIELD

The various aspects and examples thereof relate to a system for and a method of identification of a user and, upon successful identification, granting access to the user upon request.

### BACKGROUND

In on line shops, on line service providers like email providers and similar online business places, users are authenticated using a username and password. With a stolen username and password, an imposter may authenticate and get access to data of the user to whom the credentials actually belong—or purchase goods on the account of that user. Two-factor authentication is available to address this issue to some extent, but with a stolen device, a code sent by means of SMS may be obtained as well. As such, two-factor authentication provides some security, but not water-tight.

### SUMMARY

In the past individuals could only be truly identified by officers of the law, immigration, or notaries. This can only be done, when all parties (individual, the identity (passport) and officer of the law, are being present on the same location at the same time. The only identification that individual itself would get is a photo comparison wherefore a human supervisor is needed. However, around 40 years ago, when we went online, the identities: passwords, fingerprints, facial scans etc. became absent from their owners and also absent from the human supervisors, making it impossible to identify the individual online. Because any person on the planet can access through someone else's identified identity, which has been the case through the entire lifespan of the internet. In cyber (where no one has ever been identified) we have cybercrime committed by unidentified individuals. because all of us are unidentified online. A cybercriminal is again an unidentified criminal. Cyber therefore means anonymous. It is impossible to secure or identify the anonymous. International law, GDPR, international Cyber Security indicates that identities online identify the individual taking access. All laws are still based around this narrative.

Supposing more secure remedies like PSD2 where two-factor authentication becomes compulsory, which can make it more difficult to hack so also more difficult to operate. However, this still keeps the online visitor anonymous.

When an identity match is made in one of the many databases the gate opens to any person on the planet. Anyone can therefore be a hacker by simply impersonating someone else's identity. A truly identified individual cannot be impersonated therefore a system that does not use identities and identity matching, identity capturing and identity storing may be preferred to stop online ID fraud as well as ID theft.

It may be preferred to provide a service where the whole identification process is controlled by the person to be identified himself. As such, it may be preferred to provide a system that provides a universal identification platform which can provide each database on the planet with the truly identified individual. Instead of matching IDs, the individual may engage into a communication session with the universal identification platform

As such, may be preferred to, instead of matching trigger tools (ID keys) that any targets for hacking the UIP only store harmless yellow pages or phonebook equivalent information for example DOB, nationality, first name, last name, phone number, email address or others or any combination thereof to distinguish that person from the rest of the world.

Hence, in summary, it is preferred to provide means for improving security. In a system as part of such means, a trusted third party and a computer implemented platform managed by such third party may provide additional security for identification of user and authentication of access requests of such user.

A first aspect provides, in an electronic access control system comprising an electronic personal computing device, an electronic access controller and a trusted platform server, a method of identifying a user, requesting identification confirmation and providing authorisation confirmation and identification to a computer-controlled access point. The method comprises receiving, by the electronic personal computing device, a controller access data request comprising a first access identifier identifying the access process, requesting, by the electronic personal computing device, a user for user data identifying the user, receiving, by the electronic personal computing device, user data identifying the user, and validating, by the electronic personal computing device, the received user data.

The method further comprises sending, if the user data is held to be valid, by the electronic personal computing device, an access identification message comprising the first access identifier to a trusted platform server, receiving, by the trusted platform server, an access identification message comprising a first access identifier from an electronic personal computing device, sending, by the trusted platform server, an identification confirmation message to the access controller, including a second access identifier, wherein the second access identifier is based on the first access identifier. In one example, the second access identifier may be the same as the first access identifier.

Further, the method comprises receiving, by the electronic access controller, an identification confirmation message from a trusted platform server, the identification confirmation message comprising a second access identifier, validating, by the electronic access controller, the second access identifier to the first access identifier, and issuing, by the electronic access controller, an access authorisation to a computer controlled access point for granting access to the user, if the first access identifier matches the second access identifier.

This method allows for secure identification and authentication of the user for access through the gate. Further advantages of the method are discussed below.

An example of the first aspect further comprises obtaining, by the electronic personal computing device, a user identifier token identifying at least one of the personal computing device and a user of the personal computing device, sending, by the electronic personal computing device, the access point identifier and the user identifier token to the trusted platform server, the sending identifying a request of the user to pass the computer controlled access point, forwarding, by the trusted platform server, to the electronic access controller, the user identifier token; a pre-access request comprising a user identifier token identifying at least one of the personal computing device and a user of the personal computing device;, receiving, by the electronic access controller, from the trusted platform server, a pre-access request comprising the user identifier token.

This example further comprises retrieving, from an electronic memory coupled to the electronic access controller, access data, verifying, based on the user identifier token and the access data, whether at least one of the personal computing device and the user thereof is allowed to pass the computer controlled access point, sending, if the at least one of the personal computing device and the user thereof is allowed to pass the computer controlled access point, a confirmation to the trusted platform server that the at least one of the personal computing device and the user is allowed to pass, based on the user identifier, forwarding, by the trusted platform server, to the personal computing device, the confirmation, receiving, from the trusted platform server, by the personal computing device, the confirmation; in this example, the requesting a user for user data identifying the user is executed upon receiving the confirmation.

This example allows for a pre-check and pre-warning of an access request. Furthermore, it provides a check additional to the biometric verification as both communication sessions needs to relate to one session.

A second aspect provides, in an electronic personal computing device, a method of providing identification to a computer-controlled access point. The method comprises receiving a controller access data request comprising an access identifier identifying the access process, requesting a user for user data identifying the user and receiving user data identifying the user. The received user data is validated and, if the user data is held to be valid, an access identification message comprising the access identifier to a trusted platform server is sent. The received user data may for example be validated against pre-stored or earlier acquired and earlier stored user data.

This method involves three parties, a personal computing device like a smartphone or dedicated portable computing device, an access controller controlling access to a device, location or service and a trusted platform. This aspect relates to the first of these three entities. The personal computing device communicates with an access controller server that controls the computer-controlled access point that access is requested, for example by a holder of the personal electronic computing device. The access controller server notes the communication and issues an identifier by means of which the access request and the process for handling this request may be identified by one or more of the three entities indicated above.

Next, earlier of in parallel, a user may be asked by the device, for example by a written or spoken prompt, to provide data identifying the user. Such data is in an example data actually identifying the specific user, for example inextricably linked to the user, like biometric data. A username may be used, but that username may also be used by an imposter. The data received is validated to earlier stored data, which is supposed to have been entered by the rightful holder of the personal electronic computing device. If the validation is successful, the person requesting access is identified as the rightful holder of the device.

Upon the successful validation, the confirmation of the identification is sent to a trusted third party for security. In order to ensure data is handled correctly, the access identification message thus sent is provided with an identifier corresponding to the identifier issued earlier by the access controller server. As will be discussed below, the trusted third party may in the end confirm the successful identification to the access controller server.

An advantage of this system is that no credentials are sent around from device to device. Second, with a third party required to be involved, there is no sole channel between two entities that may facilitate interception or hijacking of any access requests. The only way to hijack the system, intercept messages and get access by means of the access controller server is to intercept three different communications: between the personal electronic device and the access controller server, between the personal electronic device and the trusted third party and, thirdly, between the trusted third party and the access controller server. Each communication may take place over different physical media and different networks. Therefore, it is virtually impossible to impersonate the intended holder of the personal electronic computing device an get access on behalf of the holder.

One example further comprises receiving an access confirmation of the identification from the access controller and, upon receiving the access confirmation of the identification from the access controller, obtaining access by the computer-controlled access point in cooperation with the access controller. In the end, an objective of the holder of the personal electronic device is to get access to services like a bank or an electronic shop or to a venue like a hockey stadium.

In another example, the validating comprises comparing the received user data to stored user data and the received user data is held to be valid if the received user data matches the stored user data. The data earlier stored is in this case considered to have been entered by the rightful holder of the personal electronic computing device. Hence, the validation is successful if the obtained data is provided by the rightful holder. This means that the successful validation means that the user has been validated as the person who owns or at least regularly or rightfully uses the electronic personal computing device. Data, either obtained from the user, earlier stored or both may be processed prior to the comparing, by means of one or more of hashing, compression, decompression, encryption, decryption or other.

In a further example, the controller access data request comprises a link to the trusted platform server. This allows the personal electronic computing device to send further data to the trusted platform server. The address data or other identifier data may, in another example, have been pre-stored or otherwise stored earlier or via other means in a memory of the personal electronic computing device.

In again another example, the user data is biometric data related to a physical feature of the user. An advantage is that such data can almost impossibly be provided in any way other than by the user himself.

In yet another example, the access identification message further comprises data identifying the user. Such data allows for improved tracking of data and for further authentication of the user, as additional security.

In a further example, the access request comprises user identifier data identifying the user. Such data allows for improved tracking of data and for further authentication of the user, as additional security.

In again a further example, the user identifier data comprises at least one of data identifying the user, data identifying the electronic personal computing device and personal data related to the user. Such data is conveniently obtainable and verifiable.

Yet a further example comprises receiving, from the trusted platform server, a request for identification of the user, wherein the access identification message is sent in response to the request for identification of the user. The identification request, the request to a user to identify himself, for example by providing a fingerprint or an iris for scanning, may be issued by the access controller server, but also by the trusted platform server. In such case, for example the access controller server sends data to the trusted platform server that the user wishes to identify himself. This allows the trusted platform server to send the request for identification, rather than the access controller server. The identification may also be provided without prior request from a device other than the personal electronic computing device.

Another example further comprises, prior to the receiving of a controller access data request, sending an access request to an access controller for initiating an access process. A request for access may indeed be provided by the personal electronic computing device. In another example, the request for access may be expressed by means of interaction with an input device like a button or touchscreen connected to a physical access gate, a virtual button provided in a web shop or online banking application or in another way.

In yet another example, the access request comprises data identifying the user. This is particularly advantageous if the access request comprises a data packet—as opposite to the access request comprising physical interaction with an input device like a push button.

A third aspect comprises, in an electronic access controller server, a method of requesting an identification confirmation message from an electronic personal computing device. The method comprises receiving an access request from an electronic personal computing device, providing the electronic personal computing device with a controller access data request comprising a first access identifier and receiving an identification confirmation message from a trusted platform server, the identification confirmation message comprising a second access identifier. the second access identifier is validated to the first access identifier and an access authorisation to a computer-controlled access point for granting access to the user is issued if the first access identifier matches the second access identifier.

This aspect allows for improved security, as an access request is checked by a third party. The identifier sent to the party requesting access is to match an identifier received from the trusted third party. As discussed above, these two communications may proceed via different channels, from a physical as well as a logical perspective. This makes it virtually impossible to act as an imposter, in particular if in a particular exemplary implementation this is combined with biometric data validation. This is in particular the case, as receiving the identification confirmation message with a matching identifier means, in itself and also in conjunction with the second and fourth aspect—thus forming the first aspect—, that the user has been identified as a person who he or she says he is and that the user is known and trusted by the trusted platform server.

The access request may be received actively, by means of an action by a user of the electronic personal computing device and a data message from the electronic personal computing device. Additionally or alternatively, the access request may be executed passively, by the electronic personal computing device acquiring data from the electronic access controller server without the electronic access controller server taking action. Such may be scanning of a visual identifier presented by the electronic access controller server.

In an example, the controller access data request comprises a link to the trusted platform server. If the access controller server is arranged to cooperate with a particular trusted platform server, it is in this way possible to inform the personal electronic computing device of details how to contact and/or communicate with the trusted platform server.

In another example, the access controller issues the access authorisation if the first access identifier is identical the second access identifier. The first access identifier may, without processing, be used in a circle from the access controller server, to the personal electronic computing device, the trusted platform server and to the access controller server back.

In a further example, validating the second access identifier to the first access identifier comprises processing at least one of validating the second access identifier and the first access identifier prior to verifying whether the first access identifier matches the second access identifier. In this example, rather than using one and the same identical identifier in the various communication messages within the communication circle, the first identifier may be processed to arrive at the second identifier, by any entity within the chain. If the processing is proprietary, additional security is provided, as interception of only one message to obtain an identifier for the communication does not suffice. For comparing, the processing may be undone or the first identifier may be processed in the same way.

The processing may for example comprise at least one of hashing, calculating a checksum or encryption or decryption. In another example, the second identifier is looked up in a table, using for example the first identifier.

In yet another example, the access request and the identification confirmation message comprise user identifier data identifying the user and the issuing of the access authorisation is conditional to the user identifier in the access request matching the user identifier in the identification confirmation. This example provides additional security by providing additional data to be checked for verification.

This example may further comprise comparing the user identifier in the access request to the user identifier in the identification confirmation to verify whether the user identifier in the access request matches the user identifier in the identification confirmation. This example provides additional security by providing additional data to be checked for verification.

A fourth aspect provides, in a trusted platform server, a method of providing an authorisation confirmation to an access controller. The method comprises receiving an access identification message comprising a first access identifier from an electronic personal computing device and sending an identification confirmation message to the access controller, including a second access identifier, wherein the second access identifier is based on the first access identifier. In one example, the sending takes place via a first channel different from a second channel via which the receiving takes place. The difference may be in on the physical level—wired or wireless—or on a logical level—communication protocol, for example on different layers of the OSI model. An advantage is that providing the trusted platform server provides an additional check of data and an additional chain in a link and this makes it more difficult to intercept data and act as an imposter on the network.

In another example, the access identification message comprises user identifier data, and the method further comprises searching, in an electronic memory, by the trusted platform server, stored user identifier data matching the user identifier data received with the access identification message. Furthermore, in this example, sending the identification confirmation message is conditional upon finding stored user identifier data matching the user identifier data received with the access identification message in the electronic memory. In this example, additional data is handled that may be checked, which increases security.

A further example further comprises including the user identifier data in the identification confirmation message. This example provides further data to the access controller server to check. The user identifier may, also in other aspects, be used as an identifier identifying the communication link.

Again another example further comprises processing the first access identifier to obtain the second access identifier. In this example, rather than using one and the same identical identifier in the various communication messages within the communication circle, the first identifier may be processed to arrive at the second identifier, by any entity within the chain. If the processing is proprietary, additional security is provided, as interception of only one message to obtain an identifier for the communication does not suffice. For comparing, the processing may be undone or the first identifier may be processed in the same way.

The processing may for example comprise at least one of hashing, calculating a checksum or encryption or decryption. In another example, the second identifier is looked up in a table, using for example the first identifier.

Yet a further example further comprises receiving a third access identifier from the access controller, validating the third access identifier to at least one of the first access identifier and the second access identifier and sending the identification confirmation message to the access controller upon successful validation of the third access identifier to at least one of the first access identifier and the second access identifier. Adding an additional processing for the third identifier adds security.

In again another example, the first access identifier comprises access controller identifier data identifying the access controller and the access controller identifier data is used for identifying the access controller to send the identification confirmation message to. To notify the trusted platform server of the applicable access controller server, the personal electronic computing device may in this way inform the trusted platform server where the identification confirmation data is to be sent to. Next, the trusted platform server sends the identification confirmation to the access controller server identified by means of the data received in the message.

A fifth aspect provides an electronic personal computing device for providing identification to a computer controlled access point. The device comprises a network module arranged to receive a controller access data request comprising an access identifier identifying the access process and a user interface arranged to request a user for user data identifying the user; and receive user data identifying the user. The device further comprises a processing unit arranged to validate the received user data and send, by means of the network module, if the user data is held to be valid, an access identification message comprising the access identifier to a trusted platform server.

A sixth aspect provides an electronic access controller for requesting an identification confirmation message from an electronic personal computing device. The device comprises a communication module arranged to receive an access request from an electronic personal computing device, provide the electronic personal computing device with a controller access data request comprising a first access identifier and receive an identification confirmation message from a trusted platform server, the identification confirmation message comprising a second access identifier. The device further comprises a processing module arranged to validate the second access identifier to the first access identifier and issue, by means of the communication module, an access authorisation to a computer controlled access point for granting access to the user, if the first access identifier matches the second access identifier.

A seventh aspect provides a trusted platform server for providing authorisation confirmation to an access controller. The server comprises a communication module arranged to receive an access identification message comprising a first access identifier from an electronic personal computing device and send an identification confirmation message to the access controller, including a second access identifier, wherein the second access identifier is based on the first access identifier.

An eighth aspect provides computer program product comprising instructions enabling a computer, when loaded in a memory connected to a processing unit of the computer, to execute a method according to one or more of the any of the first, second, third and fourth aspect.

An ninth aspect provides a non-transitory medium having stored thereon the computer program product the eighth aspect.

### BRIEF DESCRIPTION OF THE DRAWINGS

The various aspects and examples thereof will be discussed in further detail in conjunction with drawings. In the drawings:

FIG. 1: shows a system for user identification;

FIG. 2: shows a first flowchart depicting a process; and

FIG. 3: shows a second flowchart depicting a subroutine.

### DETAILED DESCRIPTION

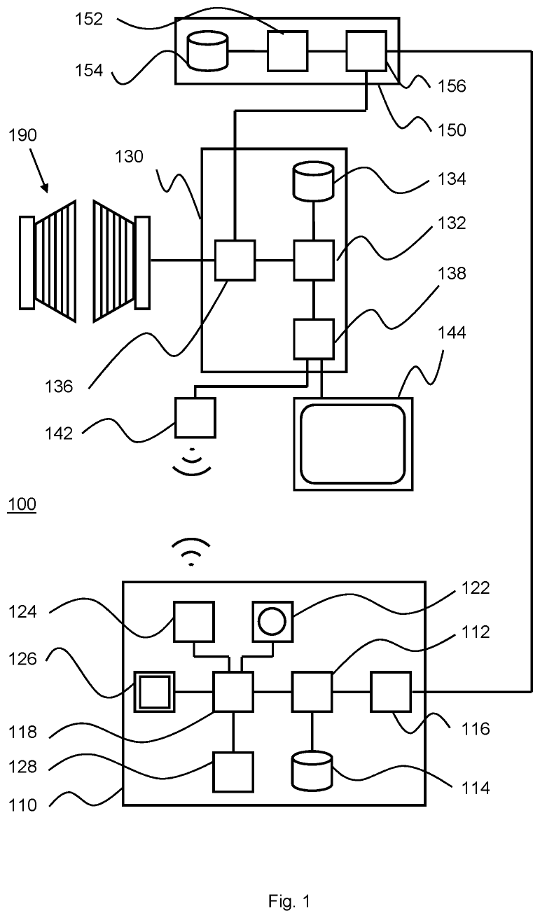

FIG. 1 shows a gatekeeping system 100 arranged to identify a user and, after identification, grant the user access through the gate 190. The gate 190 may be a physical gate, for example providing access to a stadium. Alternatively or additionally, the gate 190 may be an electronic gate providing access to data, like a data room or financial information on a back account. Alternatively or additionally, the gate 190 may provide access to services, for example payment services for payment for goods and/or services procured in a web shop, in a physical shop or at another outlet.

The gatekeeping system comprises a trusted platform server 150, a gatekeeper server 130 as an access control server and a mobile telephone 110 as a personal computing device. Alternatively or additionally, the personal computing device may be implemented as a laptop computer, a desktop computer, a tablet computer, other, or a combination thereof.

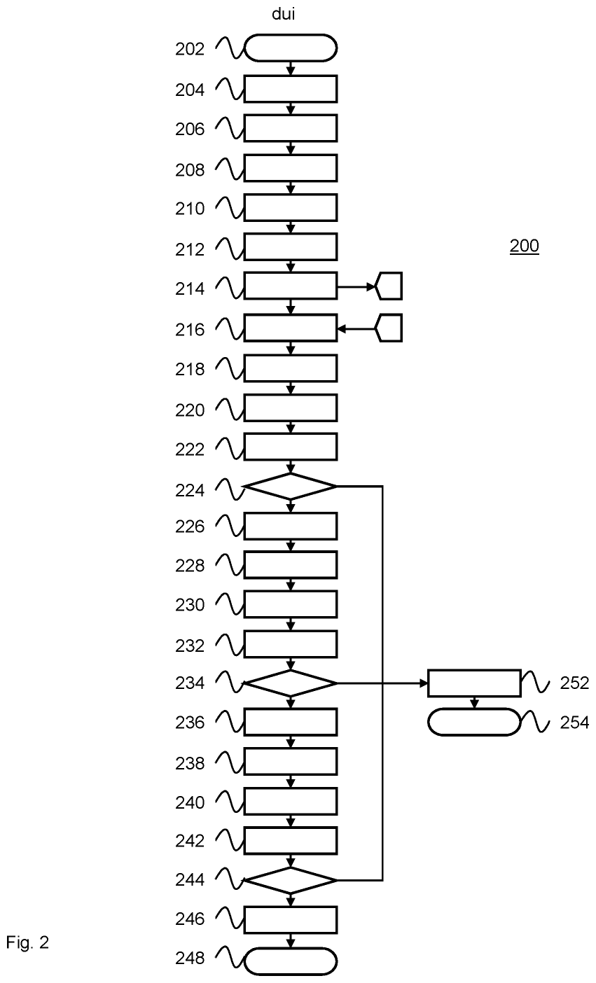

The trusted platform server 150 comprises a platform processing unit 152, a platform memory module 154 and a platform network module 156. The platform processing unit 152 is arranged to control various parts of the trusted platform server 150 and to execute one or more steps as discussed in conjunction with FIG. 2 below in further detail. The components of the trusted platform server 150 are implemented as electronic circuits; alternatively or additionally, the platform memory module 154 may comprise a hard disk drive.

The platform memory module 154 is arranged to have data stored thereon related to users to be identified by means of the gatekeeping system 100. Furthermore, the platform memory module 154 is arranged to have one or more computer programme products stored thereon comprising electronic instructions for programming the platform processing unit 152 to carry out execute one or more steps as discussed in conjunction with FIG. 2 below in further detail.

The platform network module 156 is arranged to communicate with other entities for the exchange of data, for example with other entities comprised by the gatekeeping system 100. Such communication may be executed over one or more of the public data network for electronic transmission of data colloquially known as the internet, a private network, a virtual private network provided over the internet, a local network, a wireless network such as a cellular network, other, or a combination thereof. This means that the platform network module 156 may be arranged to communicate using one or more of such networks.

The gatekeeper server 130 comprises a gatekeeper processing unit 132, a gatekeeper memory module 134, a gatekeeper network module 136 and a gatekeeper peripherals module 138. The gatekeeper processing unit 132 is arranged to control various parts of the gatekeeper platform server 130 and to execute one or more steps as discussed below in conjunction with FIG. 2. The components of the gatekeeper server 130 are implemented as electronic circuits; alternatively or additionally, the gatekeeper memory module 134 may comprise a hard disk drive.

The gatekeeper memory module 134 is arranged to have data stored thereon related to operation of the gatekeeper server 130. In particular, the gatekeeper memory module 134 is arranged to have one or more computer programme products stored thereon comprising electronic instructions for programming the gatekeeper processing unit 132 to carry out one or more steps as discussed below in further detail in conjunction with FIG. 2.

The gatekeeper network module 136 is arranged to communicate with other entities for the exchange of data, for example with other entities comprised by the gatekeeping system 100. Such communication may be executed over one or more of the public network colloquially known as the internet, a private network, a virtual private network provided over the internet, a local network, a wireless network such as a cellular network, other, or a combination thereof. This means that the gatekeeper network module 136 may be arranged to communicate using one or more of such networks. In this particular implementation, the gatekeeper network module 136 is arranged to communicate with the gate 190, for example by providing an instruction to open the gate 190 to grant access to a user.

The gatekeeper peripherals module 138 is arranged to control exchange of data between the gatekeeper processing unit 132 and peripheral device connected to the gatekeeper server 130. In particular in the implementation depicted by FIG. 1, the gatekeeper server 130 and the gatekeeper peripherals module 138 is connected to a short-range radio transceiver 142 and an electronic display device 144. The short-range radio transceiver 142 is preferably arranged to communicate with other devices using NFC—near field communication—and/or RFID—radio frequency identification—communication standards, public, proprietary or both. The peripheral devices may be provided in the same housing as the gatekeeper server 130, in a separate housing or a combination thereof.

The mobile telephone 110 comprises a telephone processing unit 112, a telephone memory module 114, a telephone network module 116 and a telephone peripherals module 118. The telephone processing unit 112 is arranged to control various parts of the telephone platform server 110 and to execute one or more steps as discussed below in conjunction with FIG. 2. The components of the mobile telephone 110 are implemented as electronic circuits.

The telephone memory module 114 is arranged to have data stored thereon related to operation of the mobile telephone 110. In particular, the telephone memory module 114 is arranged to have one or more computer programme products stored thereon comprising electronic instructions for programming the telephone processing unit 112 to carry out one or more steps as discussed below in further detail in conjunction with FIG. 2.

The telephone network module 116 is arranged to communicate with other entities for the exchange of data, for example with other entities comprised by the gatekeeping system 100. Such communication may be executed over one or more of the public network colloquially known as the internet, a private network, a virtual private network provided over the internet, a local network, a wireless network such as a cellular network, other, or a combination thereof. This means that the telephone network module 116 may be arranged to communicate using one or more of such networks.

The telephone peripherals module 118 is arranged to control exchange of data between the telephone processing unit 112 and peripheral device connected to the mobile telephone 110. In particular in the implementation depicted by FIG. 1, the mobile telephone 110 and the telephone peripherals module 118 in particular is connected to a fingerprint scanner 128 as a biometric data acquisition module, a telephone short-range radio transceiver 124, an electronic display device 126 and a camera 122.

The short-range radio transceiver 124 is preferably arranged to communicate with other devices using NFC—near field communication—and/or RFID—radio frequency identification—communication standards, public, proprietary or both. The peripheral devices may be provided in the same housing as the telephone server 150, in a separate housing or a combination thereof.

The various parts of the different entities of the gatekeeping system 100 will be discussed in further detail in conjunction with a first flowchart 200 depicted by FIG. 2. The various steps of the first flowchart 200 may be executed in an order different than depicted and various steps may be executed in series or in parallel, unless explicitly indicated otherwise. The various parts of the first flowchart 200 may be summarised as follows:
202 start procedure
204 send access request
206 receive access request
208 obtain connection ID
210 obtain platform contact details
212 provide access data request
214 obtain access data request
216 request biometric data
218 obtain biometric data
220 retrieve stored biometric data
222 validate obtained biometric data to stored biometric data
224 obtained biometric data valid?
226 retrieve user identification
228 send access identification message to platform
230 receive access identification message
232 search for user identification in platform memory
234 user identification found?
236 compose identification confirmation message
238 send identification confirmation message
240 receive identification confirmation message
242 validate connection ID received to initial connection ID
244 identification confirmation message valid?
246 issue autorisation message
248 end procedure
252 issue error message
254 end procedure

The procedure starts in a terminator 202 and proceeds to step 204 in which the mobile telephone 110 sends an access request to the gatekeeper server 130. The access request may be sent using RFID/NFC communication using the telephone short-range radio transceiver 124 and the gatekeeper short-range radio transceiver 142, using the telephone network module 116 and the gatekeeper communication module 136 by means of any network as discussed above, other, or a combination thereof.

The access request may comprise an indication that the user using the mobile telephone 110 requests access through the gate 190. The access request may further comprise data identifying the user. Such data identifying the user may be stored in the telephone memory module 114. The data identifying the user may comprise for example an email address, a telephone number, other, or a combination thereof.

In step 206, the gatekeeper server 130 receives the access request. The access request is in this example received from the mobile telephone 110. In another implementation, the access request is provided by a user directly to the gatekeeper server 130. In such implementation, the electronic display device 144 may be touchscreen arranged to obtain user input by means of touching the electronic display device 144 and by providing, based on the touching, the access request. The access request ends up in this implementation with the gatekeeper processing module 132.

In step 208, a connection identifier is obtained by the gatekeeper processing module 132. Such may be obtained in response to receiving the access request. The connection identifier may be generated upon the obtaining or may be pre-stored in the gatekeeper memory module 134. The connection identifier may also be generated or obtained not in response to receiving the access request.

In step 210, contact details for contacting the platform server 150 are obtained, for example from the gatekeeper memory module 134. Such contact details may comprise an IP address, a domain name, a MAC address, other, or a combination thereof.

In step 212, an access data request is provided such that it can be received by the mobile telephone. Firstly, the access data request is composed, based on at least one of the connection identifier and the contact details for contacting the platform server 150. The data of the access data request is subsequently cast in a data format such that data may be acquired by means of the mobile telephone 110. If for example radio transmission is used for communication, the access data request is cast in a format compatible with a applicable RFID/NFC communication standard.

In another example, the access data request is coded in a visual code, such as a quick response code, also known as a QR code, or another type of two-dimensional or one-dimensional visual binary code, like a bar code. In the latter example, the visualisation of the access data request is provided by means of the electronic display device 144 connected to the gatekeeper server 130.

The visual code may be provided upon request of a user or provided absent such request. In the latter case, no access request precedes the access data request. The visual code provides in one option a unique code to every user that scans the code. In one example, the visual code changes every second or other time interval. In another example, the visual code changes upon completion of the process depicted by the first flowchart 200. The code embedded in the visual code may provide a the connection identifier.

In one example, the code—visual code, RFID code or other code obtainable by the mobile telephone 110 and related to the gatekeeper server 130 is provided by the platform server 150 to the gatekeeper server 130 or otherwise presented to the user or provided to the platform server 150 in any way. If the code is provided on request by means of the mobile telephone 110, an identifier of the mobile telephone 110 may be sent to the platform server 110 with such request. This information may later be cross-checked by the platform server for increased security.

The visual code may be provided upon request of a user or provided absent such request. In the latter case, no access request precedes the access data request. The visual code provides in one option a unique code to every user that scans the code. If a unique code is provided to the mobile telephone 110, the unique code may also identify the user of the mobile telephone 110, for example for this particular session. In another example.

Hence, such first access identifier identifying the access process may be a static code or a dynamic code or a combination thereof. The access identifier may be provided by the platform server 150, via the gatekeeper server 130, by the gatekeeper server 130, by means of a static image, even on a sticker. The identifier may change over time, with unlimited or limited validity over time. The identifier may also comprise an identifier of the mobile telephone 110 and/or the user thereof. And two or more of such data items may be combined to form the access identifier identifying the access process.

In one example, the visual code changes every second or other time interval. In another example, the visual code changes upon completion of the process depicted by the first flowchart 200. The code embedded in the visual code may provide a the connection identifier. This is particularly advantageous if a unique code is provided. Otherwise, a connection identifier may be generated based on the code embedded in the visual code.

If the access data request is obtained by means of a visual code, in particular prior to or without any communication between the mobile telephone 110 to the gatekeeper server 130, the user of the mobile telephone 110 or the mobile telephone 110 itself may not be known with the gatekeeper server 130. In such case, an identification of the mobile telephone 110 or the user thereof may be provided later to the gatekeeper server 130.

In step 214, the access data request provided is obtained by the mobile telephone 110. If radio transmission is used, the access data request is obtained using the telephone short-range radio transceiver 124. If the access data request is provided using a visualisation of the data, the camera 122 may be used to obtain the access data request, as indicated above.

In step 216, the user of the mobile telephone 110 is requested to provide biometric data, like a fingerprint, a scan of the iris, a voice message, other, or a combination thereof, to the mobile telephone 110, as user data identifying the user. In another example, the user data identifying the user may be provided in numerical or alphanumerical format, like a password, a numerical code, a response to a personal question (“what is your mother's maiden name?”; “what is the name of your first pet?”).

A scan of the iris may be obtained using the camera 122 and fingerprint data may be obtained using the fingerprint scanner 128, in step 218. The request may be issued by a prompt on the electronic display device 126 of the mobile telephone 110, by means of playing a sound, by other means of a combination thereof. The prompt may be provided upon obtaining the access data request. Alternatively or additionally, the prompt may be provided upon sending the access request.

In step 220, biometric data of the user is retrieved from the telephone memory 114. The stored and thus retrieved biometric data has in one example been obtained earlier, for example during an initialisation procedure of the mobile telephone 110 during which the user is requested to provide biometric data. The earlier obtained biometric data may be processed, including, but not limited to using encryption, compression, hashing, other, or a combination thereof. If such is the case, the stored data may be processed to reverse the earlier processing-if possible. Alternatively or additionally, the data obtained in step 218 is processed and subsequently compared to the stored and retrieved data. Such may be practical if the stored biometric data is a hash of earlier obtained data.

In step 222, the data obtained in step 218 is validated to the stored and retrieved data. As indicated directly above, such validation may comprise comparing, of processed or unprocessed data. Based on the outcome of the comparing, it is checked in step 224 whether the validation is successful. If the validation is not successful, the user of the telephone is most probably not the same person as the person who earlier provided the biometric data.

And as it is expected that the person who provided the biometric data earlier is presumed to be the owner of the mobile telephone 110, the user from whom biometric data has been obtained in step 218 is probably an imposter. Therefore, if the validation has been determined to have failed, the procedure branches to step 252. In step 252, the telephone processing unit 112 provides an error message and the procedure ends in a terminator 254.

In one example, the user of the mobile telephone 110 has just obtained access to operation of the mobile telephone 110 by providing user data identifying the user, in order to scan a code as an example of receiving a controller access data request comprising a first access identifier identifying the access process. In such example, the unlocking of the mobile telephone 110 may be considered as fulfilling the needs of step 218 through step 224.

If the validation is successful, the user of the mobile telephone 110 is most probably the same as the owner or intended user of the mobile telephone 110. This means that the person requesting access to the person who requests access via the gate 190 is actually identified as being that person-and not another person using the mobile telephone. Therefore, the user is in such case determined to be who he or she says to be and in rightful possession of the mobile telephone 110. Therefore, the procedure continues from step 224 to step 226, in which user identification data is retrieved from the telephone memory module 114. Such user identification may be an IMEI (International Mobile Equipment Identity) number, a SIM (Subscriber Identity Module) number, a telephone number or another identifier coupled to the mobile telephone 110 or the user thereof. It may also be an IP address.

The user identification data may comprise at least one of a surname, a first name, a telephone number, a street address, an email address, a personal identification number like a social security number, a bank account number, another number of other string of numerical or alphanumerical characters, other, or a combination thereof. The retrieved data may be the actual data or a processed version thereof. Additionally or alternatively, data may be processed upon retrieval. The processing may include at least one of encryption, decryption, compression, decompression, hashing, other, or a combination thereof.

In step 228, at least one of the user identification data as a user identifier and the connection identifier is sent to the platform server 150 in one or more access identification messages by means of the telephone network module 116. The connection identifier may be processed prior to sending. The one or more access identification messages are received by the platform server in step 230 by means of the platform network module 156. If the platform server 150 is aware of the code obtainable by the mobile telephone 110, as discussed above, the platform server 150 may determine that an earlier issued code is now being used and a connection established.

As the access identification message is only sent if the user has been identified as the rightful user of the mobile telephone 110, the mere sending of the access identification message may in one example be sufficient that the user who provided the biometric data in step 216 is identified as the rightful user providing the biometric data that matches biometric data stored in the telephone memory 114 of the mobile telephone 110. In one example, the connection identifier may be provided as sole data to provide an identifier for the circular connection between the three entities depicted by FIG. 1.

The data received by means of the one or more access identification messages is provided to the platform processing unit 152 and the platform processing unit 152 searches in step 232 in the platform memory module 154 whether data of the user is available, using the data received. This means that data stored in the platform memory module 154 may be searched using at least one of the connection identifier and the user identification data.

In step 234 is checked whether data matching data that has been received by means of the one or more access identification messages has been found in the platform memory module 154. If such is not the case, the procedure branches to step 252 and proceeds as discussed above in conjunction with step 252.

If data has been found in the platform memory module 154 that matches data that has been received by means of the one or more access identification messages, the procedure continues from step 234 to step 236, in which an identification confirmation message is composed. The identification message comprises at least one of the connection identifier, data corresponding to the connection identifier, user identification data and data corresponding to user identification data. The identification confirmation message thus composed is sent to the gatekeeper server 130 in step 238.

The identification confirmation message indicates that a user who request access through the gate 190 has been identified as the owner or regular user of the mobile telephone, using biometric properties of the user and that this user is a user known by and validly registered by the trusted platform server 150.

The user may be registered and validated by the trusted platform server 150 by checking an identifier of the mobile telephone 110 or the user thereof to data stored on the trusted platform server 150. As discussed above, the identifier may be an IMEI number, a SIM number, an IP address, a telephone number or other. The user identifier received may be checked to a whitelist and/or a blacklist.

If, based on assessment of the user identifier, at least one of the mobile telephone 110 and the user thereof is on the whitelist, the identification confirmation message is processed further as indicated below. If this is not the case, the process ends.

In an analogous way, if, based on assessment of the user identifier, at least one of the mobile telephone 110 and the user thereof is on the blacklist, the process ends. If this is not the case, the identification confirmation message is processed further as indicated below.

The identification confirmation message is received by the gatekeeper server 130 in step 240 by means of the gatekeeper network module 136 and passed to the gatekeeper processing unit 132. In step 242, data in the identification confirmation message is validated to data stored in the gatekeeper memory module 134. In one example, the connection identifier obtained in step 208 is validated to a connection identifier that may be provided in the identification confirmation message.

In one example, the IP address—or other address—from an entity from which the identification confirmation message is received by the gatekeeper server 130 is checked to a server safelist. The server safelist comprises addresses allocated to the trusted platform server 150 or legit clones thereof. If the IP address—or other address—from an entity from which the identification confirmation message is received by the gatekeeper server 130 is on the server safelist, the identification confirmation message is processed by the gatekeeper server 130. Otherwise, the process ends.

In one example, the identification confirmation message is to comprise the same connection identifier. In another example, at least one of an identifier comprised by the identification confirmation message and the connection identifier obtained in step 208 is processed prior to validation, wherein the processing comprises at least one of encryption, decryption, compression, decompression, hashing, other, or a combination thereof.

In another example, the identification confirmation message may comprise data identifying the user. In such example, the gatekeeper may have received data identifying the user earlier, for example from the mobile telephone 110, for example by means of the access request received in step 206. At least one of data identifying the user received earlier and data identifying the user as received by means of the identification confirmation message may be processed and validated against one another in the same way as the connection identifier as discussed directly above.

In step 244 is checked whether the identification confirmation message is valid and corresponds to a particular access request. In general, this is done by verifying a match between the identification confirmation message received from the trusted platform server 150 matches any information received from the mobile telephone 110. This is important to provide access to the appropriate entity—computer, mobile telephone 110, physical person—following an affirmative identification confirmation message.

The verifying may be executed by verifying whether the identification confirmation message comprises the connection identifier issued earlier by the gatekeeper server 130 or has at least data matching in any way this connection identifier. Additionally or alternatively, other data that the gatekeeper server 130 has provided to the mobile telephone 110 or that the mobile telephone 110 has provided to the gatekeeper server 130 may be compared in order to determine whether a person requesting access through the gate 190 is actually the owner or regular user of the mobile telephone 110 and has been identified accordingly, in this example using biometric data. Such data may be an identifier that identifies at least one of the mobile telephone 110 or the user thereof.

In one example, the connection identifier issued earlier by the gatekeeper server 130 has a validity limited in time. In such case, the identification confirmation message is only processed if the identification confirmation message is received by the gatekeeper server 130 within a particular timeframe from issuing the connection identifier.

In another example, the gatekeeper server 130 has not received any data from the mobile telephone 110 within the process. Such may be the case if the access data request procedure as described above starts with scanning a visual identifier by means of the mobile telephone 110—which is a unidirectional data transfer. In such example, the mobile telephone 110 is to provide data identifying at least one of the mobile telephone 110 and the user thereof, which data is to allow verification that data comprised by the identification confirmation message is related to the at least one of the mobile telephone 110 and the user thereof. The providing of this data may be preceded by a request thereof by the gatekeeper server 130.

If such is not the case, the procedure branches to step 252 and proceeds as discussed above in conjunction with step 252. If such is the case, the procedure continues to step 246, in which the gatekeeper processing unit issues, by means of the gatekeeper network module 136, an authorisation message.

The authorisation message is in this example provided to the gate 190. The authorisation message may be binary—access or not. In another example, the authorisation message may comprise one or more from data identifying the validated and identified user, the connection identifier, data based on at least one of the previous two, other data, or a combination thereof. As indicated above, the opening of the gate may be the actual opening of the gate, but in other examples, the opening of the gate is a metaphor for execution of a payment, access to a payment account, purchase of goods or services, other, or a combination thereof. Subsequently, the procedure ends in step 248.

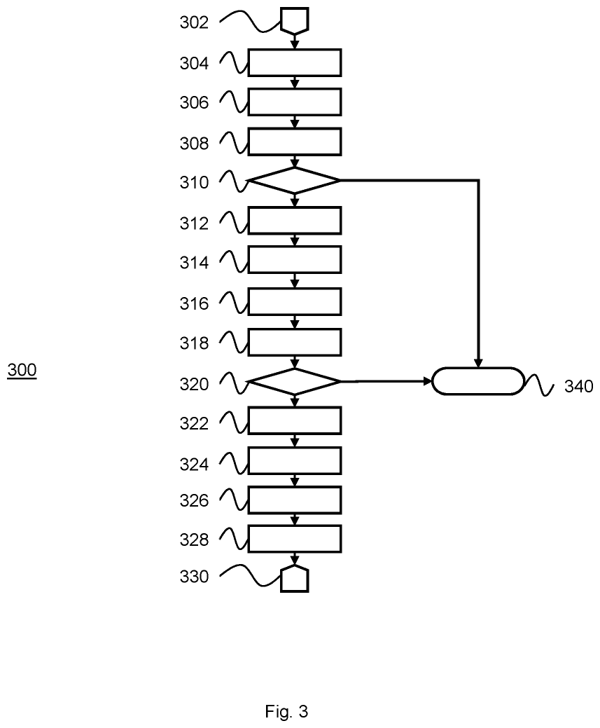

The procedure depicted by FIG. 2 may be further extended by adding a subroutine as depicted by FIG. 3. FIG. 3 shows a second flow chart 300, which depicts a subroutine to check whether the mobile telephone 110 or the presumed user thereof is allowed to pass the gate 190 anyway. The various parts of the second flowchart 300 may be briefly summarised as follows:
302 connector from the first flowchart 200;
304 receive gate data
306 send gate data to the platform server 150
308 receive the gate data from the mobile telephone 110
310 user known?
312 look up gatekeeper server identification
314 send user data to the gatekeeper server 130
316 receive user data from the platform server 150
318 verify user data to access list
320 is the user on the access list?
322 send confirmation to the platform server 150
324 receive the access confirmation
326 send a request for authentication to the mobile telephone
328 receive the request for authentication
330 connector to the first flowchart
340 end of procedure

The procedure of the subroutine depicted by the second flowchart 300 may be initiated from step 214 depicted by FIG. 2 or any applicable step preceding step 214, via connector 302. The procedure proceeds with step 304, in which the mobile telephone receives data related to the gate 190, in particular if such data has not been received before. Data identifying the gate 190 may comprise data identifying the gatekeeper server 130. In step 306, the gate data is sent to the platform server 150, accompanied with data that identifies at least one of the mobile telephone 110 or the user thereof. Such may be the connection ID, if this is an identifier unique to the mobile telephone 110 or the user thereof.

In step 308, the information sent, identifying the gate 190 and the data that identifies at least one of the mobile telephone 110 or the user thereof is received by the platform server 150. The data received is in step 310 used by the platform server 150 to verify whether the mobile telephone 110 or the user thereof is known. If this is not the case, the procedure ends in terminator 340. If the mobile telephone 110 or the user thereof is known, for example because data identifying the mobile telephone 110 or the user thereof is available in the platform storage module 154, the platform server 150 looks up data identifying the gatekeeper server 130, in particular if such data is not provided by means of the data received. The data may be looked up using an identifier of the gate 190.

If the mobile telephone 110 or the user thereof is known by the platform server 150, data identifying the mobile telephone 110 or the user thereof is sent to the gatekeeper server 130 in step 314. The data is received by the gatekeeper server 130 in step 316. Subsequently, data received is verified to data stored in the gatekeeper storage module 134 to verify whether the user has access right to pass through the gate.

The data used for verification may be that the user is a member or subscriber to a service, club, or other society to which the gate 190 provides access. Alternatively or additionally, the user may be an owner of any premise or service to which the gate 190 provides access. Additionally or alternatively, the verification may be executed by the platform server 150, if the platform server 150 has the appropriate data stored on it. It is noted that the gate 190 may be a physical gate, providing access to a stadium or concert hall, as well as it may be virtual gate providing access to a bank account or a particular one line or otherwise electronic service or other application.

In step 320, based on the verification in step 318, the procedure may branch to the terminator 340 if the user is not known by the gatekeeper server 130, is not on an access list or is not on an access list for the particular date and time during which the user requests access to pass through the gate 190. If the user is known, for example if the data initially sent by means of the mobile telephone 110 in step 306 matches data on an access list, stored by either the gatekeeper server 130, the platform server 150 or an otherwise trusted electronic entity, the procedure branches in step 320 to step 322.

In step 322, the gatekeeper server 130 sends confirmation to the platform serer 150 that the user is allowed to pass through the gate 190, based on the credentials provided by the user by means of the mobile telephone 110 (or other means for communicating with the platform server 150). The confirmation is received in step 324. If the verification of the user being on the access list is performed by the platform server 150, steps 322 and 324 may not be performed.

Following conformation that the user of the mobile telephone 110 is allowed to pass through the gate, in particular if such is the gate at a particular moment or within a particular timeframe, for example a pre-determined timeframe during which the access request was made or which timeframe started when the access request was submitted, the platform server 150 requests the user, by communicating with the mobile telephone 110, that the user is to provide authentication to verify that the user of the mobile telephone 110 is actually the real or expected user of the mobile telephone 110.

In order to confirm that the user is the expected user of the mobile telephone coupled to a service or premise the user requests access to, the platform server 150 communicates to the mobile telephone in step 326 that the user is to authenticate himself or herself by providing biometric data to the mobile telephone 110 for verification against earlier stored data. This request is received in step 328, after which step the procedure branches back to step 216 of the procedure depicted by FIG. 2.

The aspects also relate to a system that is provided comprising an access controller that can grant—or deny to a person or device an access to a location or premises like a shop or stadium, a service like money transfer with a bank, purchase of goods or services, either physical or via an electronic access point like a web shop. The access is denied or granted based on an identification of a user by means of an electronic computing device. such may be a mobile phone or another generic device, but also a dedicated device for functioning in the system. The device is arranged to collect data identifying the user, like biometric data and to verify whether the biometric data received matches biometric data related to a user, which data has been received before. The system further comprises a trusted platform server. Upon successful identification of the user, the personal computing device confirms the identification to the trusted platform. The trusted platform, in turn, notifies the access controller that identification was successful. Optionally, the trusted platform may execute a verification of user details received from the personal computing device to stored user details stored in a memory operatively coupled to the trusted platform. This allows for additional security.

1. A method of identifying a user, requesting identification confirmation and providing authorisation confirmation and identification to a computer controlled access point in an electronic access control system comprising an electronic personal computing device, an electronic access controller and a trusted platform server, the method comprising:
receiving, by the electronic personal computing device, a controller access data request comprising a first access identifier identifying an access process;
requesting, by the electronic personal computing device, a user for user data identifying the user;
receiving, by the electronic personal computing device, user data identifying the user;
validating, by the electronic personal computing device, the received user data;
if the user data is held to be valid, sending, by the electronic personal computing device, an access identification message comprising the first access identifier to a trusted platform server;
receiving, by the trusted platform server, an access identification message comprising a first access identifier from an electronic personal computing device;
sending, by the trusted platform server, an identification confirmation message to the access controller, including a second access identifier, wherein the second access identifier is based on the first access identifier;
receiving, by the electronic access controller, an identification confirmation message from a trusted platform server, the identification confirmation message comprising a second access identifier;
validating, by the electronic access controller, the second access identifier to the first access identifier;
issuing, by the electronic access controller, an access authorisation to a computer controlled access point for granting access to the user, if the first access identifier matches the second access identifier.

2. The method of claim 1, further comprising:
obtaining, by the electronic personal computing device, a user identifier token identifying at least one of the personal computing device and a user of the personal computing device;
sending, by the electronic personal computing device, an access point identifier and the user identifier token to the trusted platform server, the sending identifying a request of the user to pass the computer controlled access point;
forwarding, by the trusted platform server, to the electronic access controller, the user identifier token; a pre-access request comprising a user identifier token identifying at least one of the personal computing device and a user of the personal computing device;
receiving, by the electronic access controller, from the trusted platform server, a pre-access request comprising the user identifier token;
retrieving, from an electronic memory coupled to the electronic access controller, access data;
verifying, based on the user identifier token and the access data, whether at least one of the personal computing device and the user thereof is allowed to pass the computer controlled access point;
if the at least one of the personal computing device and the user thereof is allowed to pass the computer controlled access point, send a confirmation to the trusted platform server that the at least one of the personal computing device and the user is allowed to pass, based on the user identifier;
forwarding, by the trusted platform server, to the personal computing device, the confirmation;
receiving, from the trusted platform server, by the personal computing device, the confirmation;
wherein the requesting a user for user data identifying the user is executed upon receiving the confirmation.

3. A method of providing identification to a computer controlled access point, in an electronic personal computing device, the method comprising:
receiving a controller access data request comprising an access identifier identifying an access process;
requesting a user for user data identifying the user;
receiving user data identifying the user;
validating the received user data;
if the user data is held to be valid, sending an access identification message comprising the access identifier to a trusted platform server.

4. The method according to claim 3, further comprising receiving an access confirmation of the identification from the access controller;
upon receiving the access confirmation of the identification from the access controller, obtaining access by the computer controlled access point in cooperation with the access controller.

5. The method according to claim 3, wherein the validating comprises comparing the received user data to stored user data and the received user data is held to be valid if the received user data matches the stored user data.

6. The method according to claim 3, wherein the controller access data request comprises a link to the trusted platform server.

7. The method according to claim 3, wherein the user data is biometric data related to a physical feature of the user.

8. The method according to claim 3, wherein the access identification message further comprises user identifier data identifying the user.

9. The method according to claim 3, wherein the access request comprises user identifier data identifying the user.

10. (canceled)

11. The method according to claim 3, further comprising receiving, from the trusted platform server, a request for identification of the user, wherein the access identification message is sent in response to the request for identification of the user.

12. The method according to claim 3, further comprising, prior to the receiving of a controller access data request, sending an access request to an access controller for initiating an access process.

13. The method according to claim 12, wherein the access request comprises data identifying the user.

14. The method according to claim 3, further comprising:
receiving an access point identifier identifying the computer controlled access point;
obtaining a user identifier token identifying at least one of the personal computing device and a user of the personal computing device;
sending the access point identifier and the user identifier token to the trusted platform server, the sending identifying a request of the user to pass the computer controlled access point;
receiving, from the trusted platform server, a confirmation that the user is allowed to pass the computer controlled access point;
wherein the requesting a user for user data identifying the user is executed upon receiving the confirmation.

15. A method of requesting an identification confirmation message from an electronic personal computing device, in an electronic access controller, the method comprising:
receiving an access request from an electronic personal computing device;
providing the electronic personal computing device with a controller access data request comprising a first access identifier;
receiving an identification confirmation message from a trusted platform server, the identification confirmation message comprising a second access identifier;
validating the second access identifier to the first access identifier;
issuing an access authorisation to a computer controlled access point for granting access to a user, if the first access identifier matches the second access identifier.

16. The method according to claim 15, wherein the controller access data request comprises a link to the trusted platform server.

17. The method according to claim 15, wherein the access controller issues the access authorisation if the first access identifier is identical the second access identifier.

18. The method according to claim 15, wherein validating the second access identifier to the first access identifier comprises processing at least one of validating the second access identifier and the first access identifier prior to verifying whether the first access identifier matches the second access identifier.

19. (canceled)

20. The method according to claim 15, wherein the access request and the identification confirmation message comprise user identifier data identifying the user and the issuing of the access authorisation is conditional to the user identifier in the access request matching the user identifier in the identification confirmation.

21. The method according to claim 20, further comprising comparing the user identifier in the access request to the user identifier in the identification confirmation to verify whether the user identifier in the access request matches the user identifier in the identification confirmation

22. The method according to claim 15, further comprising:
receiving, from the trusted platform server, a pre-access request comprising a user identifier token identifying at least one of the personal computing device and a user of the personal computing device;
retrieving, from an electronic memory coupled to the electronic access controller, access data;
verifying, based on the user identifier token and the access data, whether at least one of the personal computing device and the user thereof is allowed to pass the computer controlled access point; and
if the at least one of the personal computing device and the user thereof is allowed to pass the computer controlled access point, send a confirmation to the trusted platform server that the at least one of the personal computing device and the user is allowed to pass, based on the user identifier.

23. A method of providing an authorisation confirmation to an access controller, in a trusted platform server, the method comprising:
receiving an access identification message comprising a first access identifier from an electronic personal computing device;
sending an identification confirmation message to the access controller, including a second access identifier, wherein the second access identifier is based on the first access identifier.

24. The method according to claim 23, further wherein the access identification message comprises user identifier data, the method further comprising:
searching, in an electronic memory, by the trusted platform server, stored user identifier data matching the user identifier data received with the access identification message;
wherein sending the identification confirmation message is conditional upon finding stored user identifier data matching the user identifier data received with the access identification message in the electronic memory.

25. The method according to claim 24, further comprising including the user identifier data in the identification confirmation message.

26. The method according to claim 23, further comprising processing the first access identifier to obtain the second access identifier.

27. (canceled)

28. The method according to claim 23, further comprising:
receiving a third access identifier from the access controller;
validating the third access identifier to at least one of the first access identifier and the second access identifier;
sending the identification confirmation message to the access controller upon successful validation of the third access identifier to at least one of the first access identifier and the second access identifier.

29. The method according to claim 23, wherein the first access identifier comprises access controller identifier data identifying the access controller and the access controller identifier data is used for identifying the access controller to send the identification confirmation message to.

30. An electronic personal computing device for providing identification to a computer controlled access point, the device comprising:
a network module arranged to receive a controller access data request comprising an access identifier identifying an access process;
a user interface arranged to:
request a user for user data identifying the user; and
receive user data identifying the user;
a processing unit arranged to:
validate the received user data;
send, by means of the network module, if the user data is held to be valid, an access identification message comprising the access identifier to a trusted platform server.

31. An electronic access controller for requesting an identification confirmation message from an electronic personal computing device, the device comprising:
a communication module arranged to:
receive an access request from a electronic personal computing device;
provide the electronic personal computing device with a controller access data request comprising a first access identifier;
receive an identification confirmation message from a trusted platform server, the identification confirmation message comprising a second access identifier; and
a processing module arranged to:
validate the second access identifier to the first access identifier;
issue, by means of the communication module, an access authorisation to a computer controlled access point for granting access to a user, if the first access identifier matches the second access identifier.

32. A trusted platform server for providing authorisation confirmation to an access controller, the server comprising a communication module arranged to:
receive an access identification message comprising a first access identifier from an electronic personal computing device;
send an identification confirmation message to the access controller, including a second access identifier, wherein the second access identifier is based on the first access identifier.

33. A system for identifying a user, requesting identification confirmation and providing authorisation confirmation and identification to a computer controlled access point, the system comprising:
(a) an electronic personal computing device for providing identification to a computer controlled access point, the device comprising:
a network module arranged to receive a controller access data request comprising an access identifier identifying an access process;
a user interface arranged to:
request a user for user data identifying the user; and
receive user data identifying the user;
a processing unit arranged to:
validate the received user data;
send, by means of the network module, if the user data is held to be valid, an access identification message comprising the access identifier to a trusted platform server;
(b) an electronic access controller for requesting an identification confirmation message from an electronic personal computing device, the device comprising:
a communication module arranged to:
receive an access request from a electronic personal computing device;
provide the electronic personal computing device with a controller access data request comprising a first access identifier;
receive an identification confirmation message from a trusted platform server, the identification confirmation message comprising a second access identifier; and
a processing module arranged to:
validate the second access identifier to the first access identifier;
issue, by means of the communication module, an access authorisation to a computer controlled access point for granting access to a user, if the first access identifier matches the second access identifier; and
(c) a trusted platform server for providing authorisation confirmation to an access controller, the server comprising a communication module arranged to:
receive an access identification message comprising a first access identifier from an electronic personal computing device;
send an identification confirmation message to the access controller, including a second access identifier, wherein the second access identifier is based on the first access identifier.

34. A system for identifying a user, requesting identification confirmation and providing authorisation confirmation and identification to a computer controlled access point, the system comprising one or more processing units comprised by one or more entities, wherein the one or more processing unit are arranged to execute the method of claim 1.

35. A computer program product comprising instructions enabling a computer, when loaded in a memory connected to a processing unit of the computer, to execute a method according to claim 1.

36. A non-transitory medium having stored thereon the computer program product of claim 35.
